(19) United States
(12) Patent Application Publication
(10) Pub. No.: US 2005/0186381 A1
(43) Pub. Date: Aug. 25, 2005

(54) Optically readable data storage medium

(76) Inventors: David J. Barbee, Green Bay, WI (US); Scott D. O'Connor, Green Bay, WI (US); Eugene W. Wittkopf, Suamico, WI (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/786,571

(22) Filed: Feb. 25, 2004

(51) Int. Cl. B32B 3/02

(52) U.S. Cl. 428/64.4

(57) ABSTRACT

A thin, flexible, optically readable, data storage medium is disclosed. The media comprises a thin, flexible substrate, and at least one thin, resiliently flexible, optically readable data storage carrier releasably held on the substrate. The substrate and carrier(s) thereon form a thin flexible lamination which is resiliently deformable from a substantially planar configuration to a non-planar configuration without substantial separation of the carrier from the substrate and without adversely affecting the optic readability of the carrier(s). The carrier(s) is removed from the substrate for subsequent use with an optical reading device. The resilient flexibility of the media allows it to be attached to non-planar and/or flexible surfaces of consumer products and to be distributed with flexible printed publications, including magazines, catalogs, books, newspapers, and direct mail.

### BACKGROUND OF THE INVENTION

This invention relates generally to optically readable digital data storage medium, and more particularly to compact discs (“CD's”) for storing data, audio programs, video programs and the like.

Conventional CD's are relatively rigid and must be handled, stored, packaged and transported in such a way as to minimize bending, which can damage or destroy a CD. U.S. Pat. Nos. 5,869,163 and 5,579,296 describe efforts to develop flexible CD's having the capabilities of high-speed production, high data storage capacity, and improved storage, handling and transport characteristics. These flexible CD's are used as part of an overall system which also includes a rigid, optically transparent adapter which supports a CD so that it can be played using a CD player. However, these prior flexible disc systems have various drawbacks.

### SUMMARY OF THE INVENTION

In general, this invention is directed to a thin, flexible, optically readable, data storage medium. The medium comprises a thin, flexible substrate, and at least one thin, resiliently flexible, optically readable data storage carrier releasably held on said substrate. The at least one carrier has an axis of rotation and optically readable data tracks generally concentric with the axis of rotation. The substrate and at least one carrier thereon form a thin flexible lamination which is resiliently deformable from a substantially planar configuration to a non-planar configuration without substantial separation of the carrier from the substrate and without adversely affecting the optic readability of the at least one carrier. The at least one carrier is adapted to be removed from the substrate for subsequent use with an optical reading device which is operable to rotate the at least one carrier to read said data tracks on the carrier.

In another aspect, a thin, flexible, optically readable, data storage medium of this invention comprises a thin, flexible substrate, and at least one thin, resiliently flexible optically readable data storage carrier releasably held on the substrate by a holding force having a peel strength in the range of 10-60 gr. The at least one carrier is adapted to be peeled off the substrate for placement on a rotatable optical reading device operable to read data on the at least one carrier.

In yet another aspect, the present invention involves a thin, resiliently flexible, optically readable, data storage medium in combination with a consumer product. The combination comprises a thin, flexible substrate and at least one thin, resiliently flexible, optically readable data storage carrier releasably held on the substrate. The at least one carrier has an axis of rotation and optically readable data tracks generally concentric with the axis of rotation. The substrate and the at least one carrier thereon form a thin resiliently flexible lamination resiliently deformable from a planar configuration to a non-planar configuration without substantial separation of the at least one carrier from the substrate and without adversely affecting the optic readability of the carrier. The lamination is releasably secured by suitable material to a surface of the aforesaid consumer product in a position wherein the at least one carrier is accessible for removal from the substrate whereupon the at least one carrier is adapted resiliently to return to its planar configuration for subsequent use with an optical reading device which is operable to rotate the carrier to read the data tracks on the carrier.

Further, this invention is directed to a thin, resiliently flexible, optically readable, data storage medium in combination with a printed publication. This combination comprises a thin, flexible substrate and at least one thin, resiliently flexible, optically readable data storage carrier releasably held on the substrate. The at least one carrier has an axis of rotation and optically readable data tracks generally concentric with the axis of rotation. The substrate and carrier thereon form a thin resiliently flexible lamination resiliently deformable from a planar configuration to a non-planar configuration without substantial separation of the at least one carrier from the substrate and without adversely affecting the optic readability of the carrier. The lamination forms an integral part of the printed publication, and the at least one carrier is adapted to be removed from the substrate for use with an optical reading device which is operable to rotate the carrier to read the data tracks on the carrier.

Other features of this invention will be in part apparent in part pointed out hereinafter.

### BRIEF DESCRIPTION OF THE DRAWINGS

FIG. 1 is a schematic view of a data storage medium of this invention, illustrating a thin, resiliently flexible individual sheet comprising a single data storage carrier, the sheet being cut from of continuous web of material having a series of data storage carriers thereon;

FIG. 2 is an enlarged view of the individual sheet of FIG. 1;

FIG. 3 is a perspective of a thin, resiliently flexible data storage carrier being removed from a substrate;

FIG. 4 is an exploded view of a data storage carrier and an adapter for supporting the carrier;

FIG. 5 is an enlarged sectional view (not to scale) on lines 5-5 of FIG. 2;

FIG. 6 is an enlarged sectional view showing the individual sheet of FIGS. 1 and 2 resiliently bent to have a curved configuration;

FIG. 7 is a plan view showing a carrier placed in an initial non-locked position on the adapter;

FIG. 8 is a plan view similar to FIG. 7 showing the carrier twisted (rotated) to a locked position on the adapter;

FIG. 9 is an enlarged sectional view on lines 9-9 of FIG. 7;

FIG. 9A is an enlarged sectional view on lines 9A-9A of FIG. 8;

FIG. 10 is an enlarged sectional view on lines 10-10 of FIG. 7;

FIG. 11 is a schematic view showing a continuous lamination of this invention being rolled up as a roll;

FIG. 12 is a view similar to FIG. 11 showing a length of the lamination dispensed from the roll and cut to form an individual sheet;

FIG. 13 is a view showing a plurality of sheets, each comprising a single data storage carrier, mounted on a display rack;

FIGS. 14 and 15 are schematic views illustrating examples of how color graphics may be applied to data storage medium of this invention;

FIG. 16 is a schematic view illustrating an example of how a lamination of this invention may be applied to a non-planar surface of a consumer product;

FIG. 17 is a schematic view illustrating an example of how a lamination of this invention may be applied to a flexible bag;

FIG. 18 is a schematic view illustrating an example of how a lamination of this invention may be applied to a magazine page;

FIG. 19 is a schematic view illustrating an example of how a lamination of this invention may be applied to a flexible insert to be placed in a magazine;

FIG. 20 is a schematic view illustrating an example of how a lamination of this invention may be applied to a flexible insert to be placed in a newspaper; and

FIG. 21 is a schematic view illustrating a series of sheets cut from a continuous web, each sheet including a single data storage carrier thereon.

Corresponding parts are designated by corresponding reference numbers throughout the drawings.

### DETAILED DESCRIPTION OF PREFERRED EMBODIMENTS

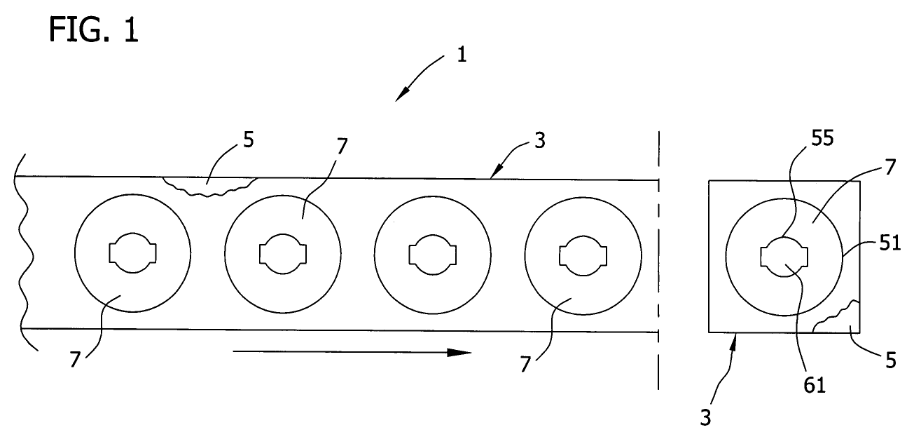

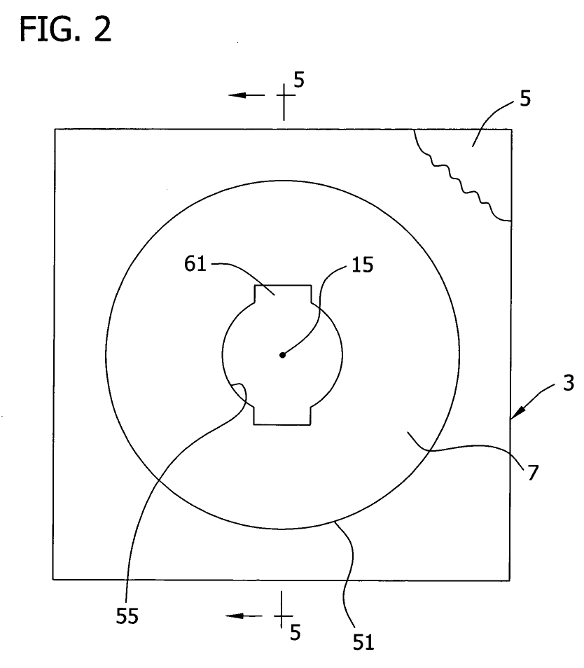

Referring now to the drawings, and first more particularly to FIG. 1, a data storage medium of the present invention is designated in its entirety by the reference numeral 1. As shown, the medium 1 comprises a thin, resiliently flexible lamination 3 comprising a substrate 5, and at least one thin, resiliently flexible, optically readable data storage carrier (e.g., CD) 7 releasably held on the substrate 5. (As used herein, the term “CD” means any type of compact disc having data tracks which can be read by an optical reader.) In the embodiment of FIG. 1, the lamination 3 is a continuous web of thin, flexible material comprising a single row of data storage carriers 7 spaced at regular intervals along the substrate 5, but it will be understood that the lamination could have other forms, such as individual sheets of any shape (see FIG. 2, for example), and that one or more carriers 7 could be arranged in virtually any formation on the substrate without departing from the scope of this invention, as will be described later. The data storage medium 1 may be formed by a continuous lamination process in which various layers of material are laminated together and then die cut to form individual carriers 7 on the substrate. Other processes may also be used.

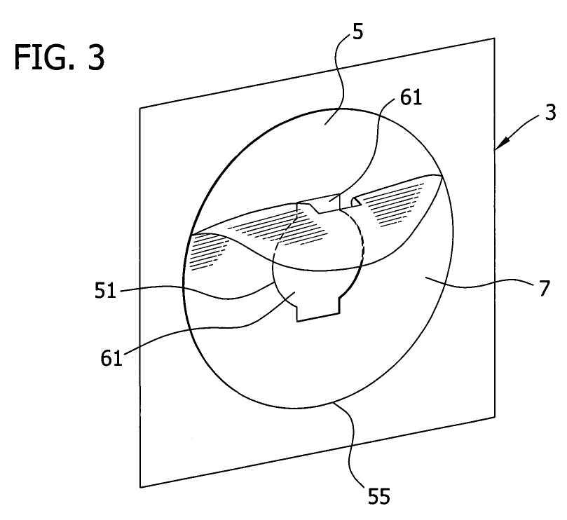

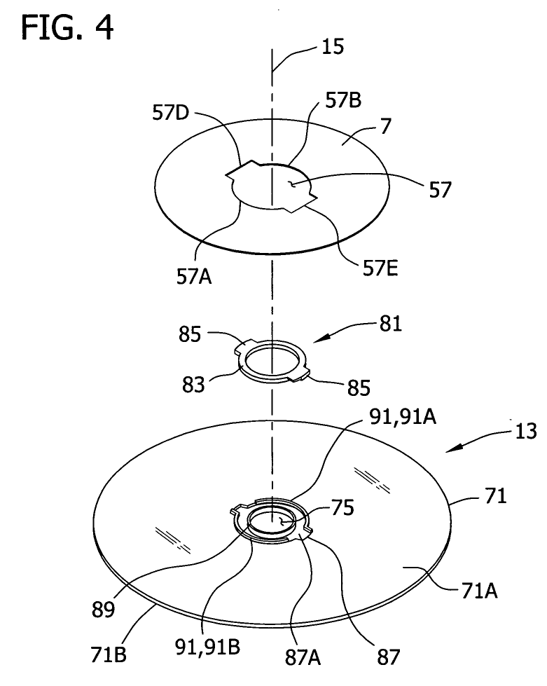

In general, and as will be described in detail hereinafter, each data storage carrier 7 is adapted to be removed from the substrate (5 see FIG. 3) for subsequent placement on an adapter, generally designated 13 (see FIG. 4). The adapter 13 is compatible with an optical reading device which rotates the adapter/carrier about an axis of rotation 15 and reads concentric data tracks on the carrier using conventional techniques. By way of example, the optical reading device may be an audio CD player, a computer CD player, a CD/DVD-ROM player, or a CD-R/RW player.

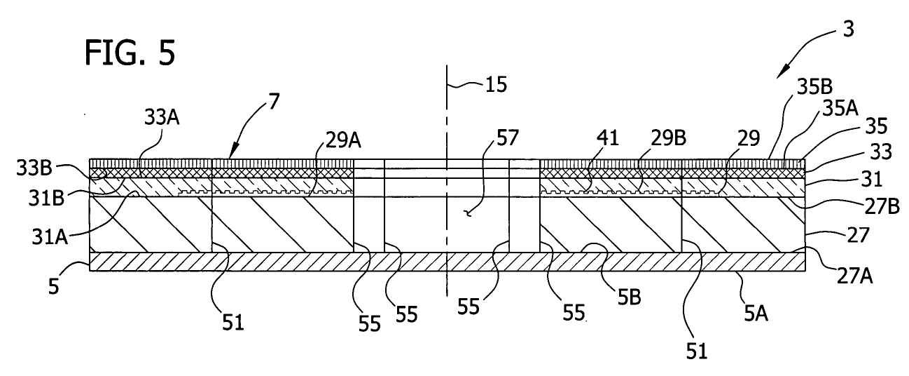

FIG. 5 is a cross sectional view showing the layers of one embodiment of the lamination 3. The substrate 5 of the lamination (the bottom layer as viewed in FIG. 5) has two opposing faces 5A, 5B, the first of which (5A) faces away from the carrier 7 and the second of which (5B) faces toward the carrier. The substrate 5 functions to protect the optical surface of each carrier 7 (i.e., the surface through which the laser beam of an optical data reading device will pass when the carrier is placed on the adapter 13 for playing) prior to the time the carrier is removed from the substrate. The substrate 5 desirably has physical properties suitable for this function. For example, in one embodiment, the substrate comprises a thin, flexible, non-resilient, limp, non-self-supporting, polymeric (e.g., a polyolefin such as polyethylene) film having the following physical properties: specific gravity in the range of 0.67-1.4, more preferably in the range of 0.8-1.1, and even more preferably about 0.93; a tensile strength measured using ASTM test procedure D-882 in the range of 15-30 Mpa, more preferably in the range of 20-25 Mpa, and even more preferably about 23.4 Mpa; a tear strength measured using ASTM test procedure D1922-84 in the range of 25-600 gr/mm, more preferably in the range of 75-300 gr/mm, and even more preferably about 150 gr/mm. The substrate preferably has a thickness in the range of 25-75 microns, more preferably in the range of 25-65 microns, even more preferably in the range of 25-50 microns, and still more preferably about 38 microns.

One exemplary substrate film product is commercially available from Tredegar Film Products of Richmond Va., and sold under the trademark ULTRAMASK 2000® film, designation X25612. This film is a polyethylene masking film having the following properties: a specific gravity of 0.923; a thickness of about 38 microns; a machine direction tensile strength of about 23.4 Mpa (using ASTM test procedure 882-95A); a transverse direction tensile strength of about 19 Mpa (using ASTM test procedure 882-95A); a machine direction elongation percentage of about 475% (using ASTM test procedure 882-95A); a transverse direction elongation percentage of about 540% (using ASTM test procedure 882-95A); a machine direction Elmendorf test reading of about 150 grams indicating the weight required to complete an already initiated tear (using ASTM test procedure D1922-84); a transverse direction Elmendorf test reading of about 425 grams indicating the weight required to complete an already initiated tear (using ASTM test procedure D1922-84); a coefficient of friction of about 0.55; and a visible light (380-720 nm) transmission percentage of about 92%. In this embodiment, the film also has a 180-degree peel strength of about 165 gms, using a test method in which the “mask” film is placed on a 1/16 in.-thick polycarbonate sheet and is nipped at room temperature (about 72° F.) under 80 psi. The lamination is then placed in an oven and heated at 100°0 C. for 5 minutes, following which the composite is again nipped under the same conditions as before and allowed to cool to room temperature for a minimum of 15 minutes. The 180-degree peel force is then measured on a one-inch wide sample, using a conventional Chatillion strain gage force-measuring device moving at a speed of 8.5 mm per second.

It will be understood that other substrate materials may be used without departing from the scope of this invention.

In the embodiment shown in FIGS. 2 and 5, the flexible lamination 3 also includes a plurality of carrier layers superposed on the substrate 5, five such layers being indicated at 27, 29, 31, 33, 35. These layers form the various layers of each data storage carrier 7.

The first carrier layer 27 comprises a layer of optically generally transparent material having a first (lower as viewed in FIG. 5) face 27A superposed on the second (supporting) face 5B of the substrate 5 and second (upper) opposing face 27B. This carrier layer 27 should have characteristics suitable for supporting the other layers of the carrier 7. Preferably, this layer 27 is both flexible and resilient, which enables the carrier to be resiliently flexed in a manner to be described later. In one embodiment, the first carrier layer 27 comprises a polycarbonate film having a thickness in the range of 25-500 microns, more preferably in the range of 50-400 microns, more preferably in the range of 100-300 microns, even more preferably in the range of 150-250 microns, and still more preferably about 180 microns.

Desirably, the first carrier layer 27 should transmit at least 60% visible light having a wavelength in the range of 425-720 nm, more preferably at least 70% of such light, still more preferably at least 75% of such light, more preferably at least 80% of such light, even more preferably at least 85% of such light, and yet more preferably at least about 89% or higher of such light, as measured using ASTM test procedure D-1003. It is also preferred that this layer 27 transmit at least 75%, and preferably at least 80% of light having a wavelength of 780 nm, using the same test procedure ASTM D-1003. It will also be understood that the carrier 7 of this invention may be used with optical readers using laser light other than visible light, including light of virtually any wavelength, in which case the first carrier layer should have light transmission characteristics suitable for transmitting such light.

Further, using ASTM test procedure D-1003, the first carrier layer 27 has a preferred “haze” of less than 15%, more preferably less than 10%, more preferably less than 7%, more preferably less than 5%, even more preferably less than 4%, even more preferably less than 3%, still more preferably less than 2%, and most desirably less than 1%.

Still further, the first carrier layer 27 preferably has an optical retardation (light distortion characteristic), as measured using ASTM test procedure F-218, in the range of 1-1500 nm, more preferably in the range of 10-1300 nm, more preferably in the range of 20-1100 nm, still more preferably in the range of 30-900 nm, yet more preferably in the range of 40-700 nm, and most desirably less than about 100 nm. Still further, the first carrier layer 27 has a suitable refractive index, such as 1.55 plus or minus 20%.

Preferably, the first carrier layer 27 has a Young's modulus of elasticity, as measured using ASTM procedure D-790, in the range of 1200-2750 Mpa, more preferably in the range of 1375-2575 Mpa, yet more preferably in the range of 1550-2415 Mpa, even more preferably in the range of 1900-2240 Mpa, and still more desirably about 2070 Mpa. By way of example, the tensile strength of the first carrier layer 27, as measured using ASTM test procedure D-882, is in the range of 35-345 Mpa, more preferably in the range of 50-275 Mpa, more preferably in the range of 55-210 Mpa, more preferably in the range of 60-210 Mpa, and yet more preferably greater than about 60 Mpa. The first carrier layer 27 also has a suitable flexural modulus, as measured by test procedure ASTM D-790. For example, the flexural modulus of this layer 27 may be in the range of 1200-3450 Mpa, more preferably in the range of 1380-2760 Mpa, still more preferably in the range of 1550-2585 Mpa, and even more preferably about 2275 Mpa.

In one embodiment, the first carrier layer 27 has a Vicat softening temperature in the range of 60-150° C., more preferably in the range of 80-140° C., still more preferably in the range of 100-130° C., and yet more preferably greater than about 125° C. The layer 27 also may also have a coefficient of friction of about 0.6.

The second carrier layer 29 comprises a layer of resin material, having a first (lower as viewed in FIG. 5) face 29A superposed on the second (upper) face 27B of the first layer 27, and a second (upper) face 29B having data tracks 41 formed (e.g., impressed) thereon. The data tracks 41 comprise a series of pits or cavities (also designated 41) readable by an optical reader. The data tracks 41 may be formed in a suitable manner, as by impressing the tracks into the resin, and are of size, shape and dimension as appropriate or required for the format of the CD itself and the disc reader requirements. The data pits can be three-dimensional, having a width, length and depth, or they can be two-dimensional, having a width and length but no depth. Further, the data tracks 41 can be formed at other locations in the carrier 7, such as the first face 29A of the resin layer 29, or in the second (upper) face 27B of the first layer 27, or in other layers of the carrier as appropriate.

By way of example, the second carrier layer 29 may comprise a coating of optically substantially transparent UV-cured acrylic resin applied to the first carrier layer 27 to a thickness in the range of 1.0-10.0 microns, more preferably in the range of 1.5-8.0 microns, even more preferably in the range of 2.0-6.0 microns, still more preferably in the range of 2.5-4.0 microns, and still more preferably about 3.0 microns. The material making up the layer 29 preferably has about the same light transmission characteristics as the first layer 27 of the carrier, and a refractive index in the range of 1.5-1.65, more preferably in the range of 1.55-1.61, and still more desirably about 1.585. Of course, the data pits 41 formed in the material distort these light transmission characteristics, as they are intended to do.

The third carrier layer 31 comprises a metallized layer of suitable foil, for example, capable of reflecting incident laser light from a CD player. The layer 31 has a first (lower as viewed in FIG. 5) face 31A superposed on the second (upper) face 29B of the second layer 29, and a second (upper) face 31B. By way of example, this metallized layer 31 may be of copper, aluminum, gold, silver or platinum, and have a thickness in the range of 100-900 angstroms, more preferably in the range of 150-700 angstroms, even more preferably in the range of 200-500 angstroms, and still more preferably in the range of 300-400 angstroms. The third carrier layer 31 is deposited on the second carrier layer 29 so that it adheres to the second layer, completely covers the second layer with substantially no holes, and conforms to the pit structure forming the data tracks 41. The metallized layer may be formed by a conventional process, such as vacuum vapor deposition, sputtering, wet silvering, or a chemical deposition process of the type described in U.S. Pat. No. 5,652,021. Preferably, the metallized carrier layer 31 reflects at least 70% of incident laser light from a CD-player, and more preferably at least about 75% of such light.

The fourth carrier layer 33 protects the metallized layer 31 and has a first (lower as viewed in FIG. 5) face 33A superposed on the second (upper) face 31B of the metallized layer 31, and a second (upper) face 33B. By way of example, the fourth layer 33 may comprise a coating of lacquer or other suitable protective material, such as a cationic, UV-cured, epoxy system using a suitable photo-acid catalyst which provides good adhesion to the metallized layer 31 and good flexibility. Alternatively, the material may be a UV-cured, free radical acrylate system. The layer 33 is preferably applied to the third carrier layer 31 to a thickness in the range of 1.0-10.0 microns, more preferably in the range of 1.5-8.0 microns, even more preferably in the range of 2.0-6.0 microns, still more preferably in the range of 2.5-4.0 microns, and still more preferably about 3.0 microns. The protective carrier layer 33 should not substantially inhibit flexibility of the lamination, and should not crack or deteriorate when the lamination/carrier is flexed.

The fourth carrier layer 33 can be substantially clear, or a pigment can be added to the layer so that the layer provides a background (e.g., a white background) suitable for applying ink graphics. By way of example, a titanium dioxide pigment may be used to provide a white background. If ink graphics are to be applied to the lamination 3, the fourth layer 33 should be ink-receptive.

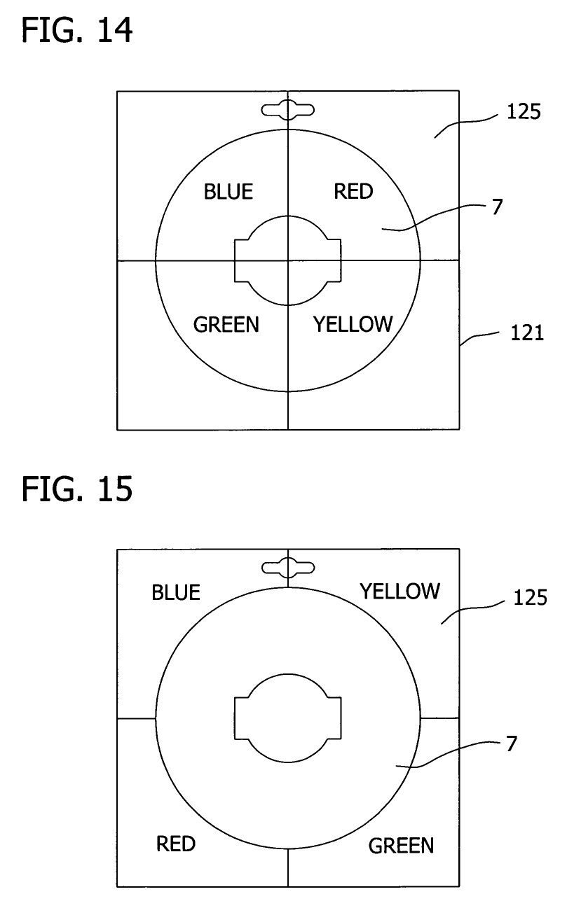

The fifth carrier layer 35 comprises a print layer of a suitable ink or the like for displaying graphics on the carrier 7. The layer 35 has a first (lower as viewed in FIG. 5) face 35A superposed on the second (upper) face 33B of the fourth layer 33, and a second (upper) face 35B. By way of example, the graphics layer 35 may comprise a UV-cured ink applied to the fourth carrier layer 33 to a thickness in the range of 1.0-10.0 microns, more preferably in the range of 1.5-8.0 microns, even more preferably in the range of 2.0-6.0 microns, still more preferably in the range of 2.5-4.0 microns, and still more preferably about 3.0 microns. The ink can be applied as a solid layer of ink or as a matrix of small but separate ink dots. If more than one color is used, the different colors may be applied as solid layers over adjacent but discrete areas (see FIGS. 14 and 15), or as a matrix of intermingled dots of different colors.

While five carrier layers 27, 29, 31, 33, 35 are shown in FIG. 5, it will be understood that a carrier 7 can have more or less than five layers. For example, the fifth (graphics) layer 35 may be eliminated entirely. Further, in the embodiment shown in FIG. 5, the first (27), third (31), fourth (33) and fifth (35), carrier layers extend across the entire width of the substrate 5 from one side of the substrate to the other, while the second carrier layer 29 (the resin layer) extends less than the full width of the lamination. Alternatively, all or any number less than all of the carrier layers may extend the full width of the lamination 3. However, it is preferable that at least the resilient supporting layer of the carrier 7 (the first layer 27 in FIG. 5) extend the full extent (width and length) of the lamination to give the overall lamination in general, and the carrier in particular, a flexible resilience.

The overall thickness of the carrier 7 may vary. Typically, such thickness is in the range of 35-510 microns, more preferably in the range of 60-410 microns, more preferably in the range of 110-310 microns, even more preferably in the range of 160-270 microns, and still more preferably about 190 microns. In one embodiment, the carrier 7 has a thickness which is only 15% or less than the thickness of a standard rigid CD.

The overall thickness of the entire lamination 3, including the carrier layers and the substrate 5, is preferably in the range of 100-500 microns, more preferably in the range of 175-350 microns, even more preferably in the range of 200-275 microns, and more preferably about 225 microns.

In one embodiment, the flexural modulus of the carrier 7 and overall lamination 3 is about the same as that of the relatively thick and resilient carrier layer 27.

As shown in FIGS. 2 and 5, for example, each carrier 7 is defined by cut lines in the lamination 3, including one or more outer cut lines 51 forming an outer peripheral edge of the carrier 7 and one or more inner cut lines 55 forming an inner peripheral edge defining a central aperture 57 in the carrier. The central aperture 57 enables the carrier 7 to be mounted on the adapter 13 for use with a CD player (see FIG. 4). The cuts 51, 55 are preferably substantially entirely through all of the carrier layers but not through the substrate 5, so that each carrier 7 preferably remains in place on the substrate until such time as it is removed (e.g., peeled off), at which time the “core” or central area 61 of the carrier 7 defined by the inner cut line(s) 55 is separated from the carrier to create the central aperture 57 in the carrier. The cut lines 51, 55 are preferably single continuous lines of cut, but they could be formed by perforated lines of weakness or other variations.

The specific shape of the central aperture 57 in the carrier 7 can vary. In the embodiment shown in the drawings (e.g., FIG. 4), the central aperture 57 is defined by a pair of opposing arcuate edges 57A, 57B lying on a circle concentric with the axis of rotation of the carrier 7, and a pair of opposing generally rectangular notch edges 57D, 57E connecting the arcuate edges and lying on the outside of the circle defined by the arcuate edges. However, the central aperture 57 can vary without departing from the scope of this invention.

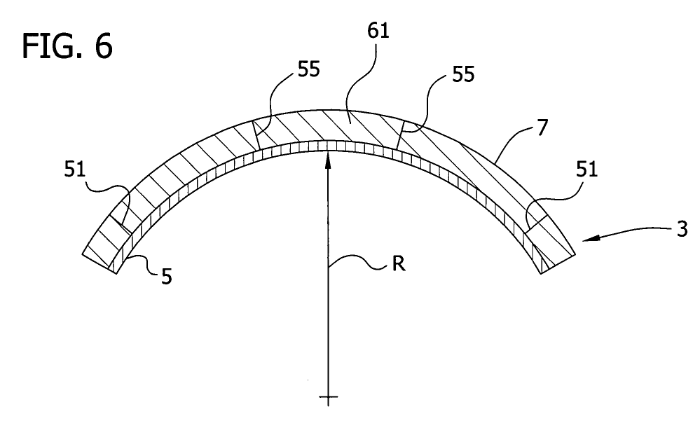

Significantly, the lamination 3 of this invention, including each carrier 7 on the lamination, is sufficiently thin and resiliently flexible that it can be deformed and even repeatedly flexed between a relaxed, substantially planar configuration, as shown in FIG. 5 for example, and a non-planar (e.g., curved) configuration, as shown in FIG. 6 for example, without adversely affecting the optic readability of a carrier. In addition, the characteristics of the substrate 5 and first carrier layer 27 are such that the carrier(s) 7 is releasably held on the substrate by a holding force which is sufficiently large and aggressive to allow deformation (e.g., bending) of the lamination 3 without any premature separation of the carrier 7 from the substrate 5, or at least without any substantial premature separation of the carrier from the substrate. (As used herein, the term “substantial separation” means a separation sufficient to adversely affect the readability of the data on the carrier 7, as by the entry of contaminants between the separated layers, or a separation sufficient to permit snagging of an exposed edge of the carrier 7 that might result in an unintentional release of the carrier from the substrate 5.) Desirably, the lamination 3 and carrier 7 should be resiliently bendable, and preferably repeatedly resiliently bendable, to have a curvature having a radius R (FIG. 6) in the range of about 20 mm-500 mm, more desirably in the range of about 30 mm-200 mm, and even more desirably in the range of about 35 mm-100 mm, without separation (delamination) of the layers of the lamination, and without adversely affecting the optic readability of the carrier. On the other hand, the holding force between the substrate 5 and each carrier 7 should be sufficiently small that the carrier can be released (removed) from the substrate by the user of the carrier without damage to the carrier. In one embodiment, the holding force has a peel strength in the range of 10-60 grams, more preferably in the range of 15-40 grams, more particularly in the range of 16-26 grams, and even more particularly about 25 grams, using the 180-degree peel test described above.

The holding force between the substrate 5 and carrier 7 may be generated in different ways, such as by the application of heat and/or pressure during formation of the lamination 3, or by making the finishes of the two mating surfaces 5B, 27A sufficiently smooth (e.g., less than 2 rms) to generate an attraction force between the two faces as described in U.S. Pat. No. 5,100,709, incorporated herein by reference in its entirety, or by imparting a static charge to one or both surfaces during the manufacturing process, or any combination of the above. Adhesive may also be used to secure the carrier 7 to the substrate 5. However, if an adhesive is used, preferably it should adhere more aggressively to the substrate 5 than to the carrier 7, so that when the carrier is removed from the substrate, the carrier is free of adhesive which might otherwise interfere with the optical reading of the data tracks 41 on the carrier.

The inside and outside diameters of the apertured carrier 7 may vary. By way of example, the outside diameter of the carrier 7 may be about 120 mm, but it could be more or less. Further by way of example, the inside diameter between the arcuate edges 57A, 57B of the carrier 7 may be in the range of 15-55 mm.

Referring to FIG. 4, the adapter 13 comprises a rigid support 71 (sometimes referred to as a “lens”) of optically transparent material having a carrier-supporting surface 71A, an opposite surface 71B, and a central aperture 75 in the support. The support 71 is of an optically transparent material (e.g., polycarbonate or acrylic), substantially rigid, and sized for use in a CD player. By way of example, the support 71 may have a thickness in the range of 800-1120 microns, more preferably in the range of 850-1050 microns, even more preferably in the range of 900-1000 microns, and yet more preferably about 950 microns. It may have the same tensile strength, Vicat softening temperature, light transmission and haze characteristics as the first carrier layer, and it may have a preferred optical retardation in the range of 1-100 nm, more preferably in the range of 10-70 nm, even more preferably in the range of 15 -50 nm, still more preferably in the range of 20-40 nm, and yet more preferably about 30 nm. In one embodiment, the support 71 has a refractive index of about 1.585, but this number can vary. The support 71 should be essentially free of optical defects (e.g., air bubbles, voids, black spots) which would interfere with the transmission of laser light through the adapter.

Referring to FIG. 4, a securing mechanism, generally designated 81, is provided for releasably securing a flexible carrier 7 to the rigid support 71 with the carrier superposed flat on surface 71A of the support. In the embodiment of FIG. 4, the securing mechanism 81 comprises an annular hub 83 formed with a pair of diametrically opposite flanges 85 projecting laterally outward from the hub. The hub 83 is secured (e.g., adhesively bonded or heat welded) in a recess or cavity 87 in the carrier-supporting surface 71A of the support 71. The recess has a bottom surface 87A, an inner upstanding wall 89 extending up from the bottom surface 87A around the central aperture 75 in the support and an outer upstanding wall 91 extending up from the bottom surface and comprising one or more wall segments spaced radially outward from the inner wall, two such wall segments 91A, 91B being shown in FIG. 4.

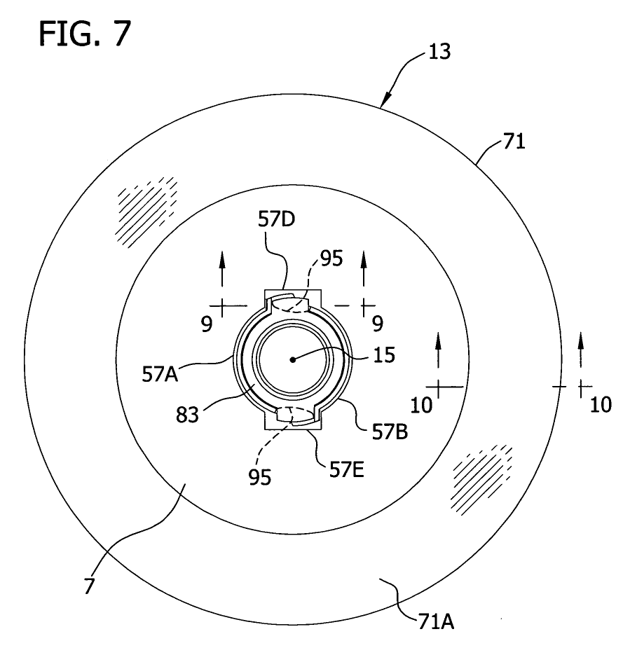

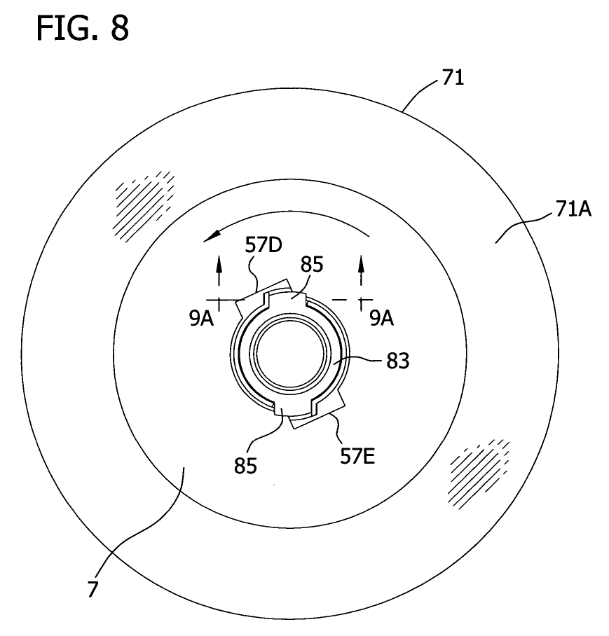

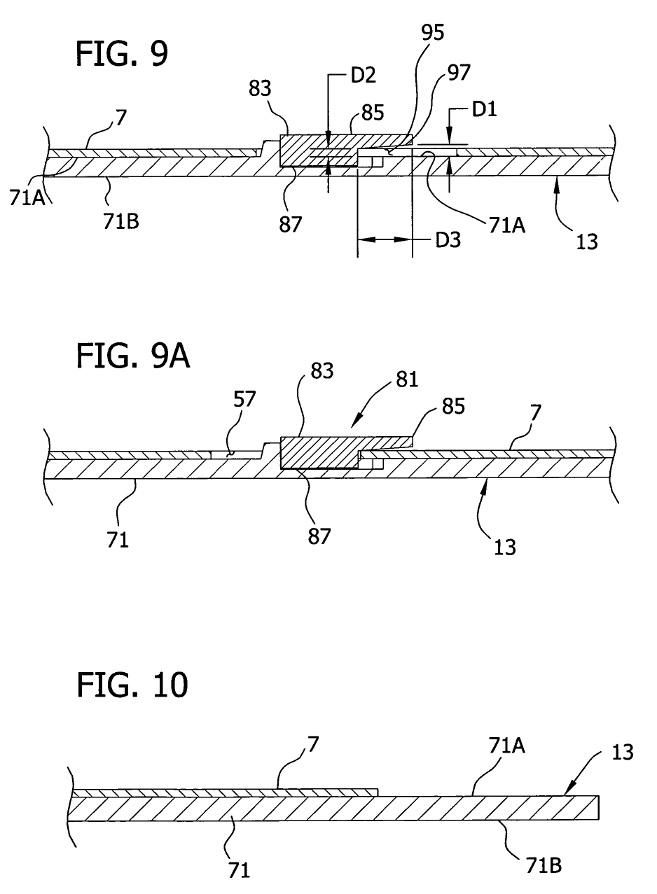

As shown best in FIG. 9, the flanges 85 of the securing mechanism 81 are dimensioned and contoured so that when the hub 83 is secured in place in the cavity 87, slots 95 are formed between bottom surfaces 97 of the flanges 85 and the carrier-supporting surface 71A of the rigid support. (Only one such slot 95 is shown in FIG. 9, the other slot being formed between the opposite flange 85 and surface 71A of the adapter support 71.) The central aperture 57 in the carrier 7 is sized and shaped to receive the hub 83 and its flanges 85, the arrangement being such that when the carrier is placed on the carrier-supporting surface 71A of the adapter with the hub 83 received in the central aperture 57 in the carrier, the carrier can be twisted (rotated) from the unlocked position shown in FIG. 7 to the locked position shown in FIG. 8 in which portions of the carrier adjacent the central aperture 57 are received in the aforementioned slots 95 to lock the carrier in fixed position relative to the adapter 13 so that the carrier can be played when the adapter is inserted into a CD player. To remove the carrier 7 from the adapter 13, the carrier is simply rotated in the opposite direction back to the unlocked position shown in FIG. 7 in which the opposing notch recesses of the central aperture 57 in the carrier 7 are aligned with the flanges 85 of the hub 83.

In the embodiment shown in FIGS. 9 and 9A, the slots 95 defined between carrier-supporting surface 71A of the adapter 13 and the flanges 85 of the hub 83 are tapered in a circumferential direction from one end of the slot (the open end as illustrated) to the other end of the slot (the closed end as illustrated). Each tapered slot 95 desirably has an open-end dimension D1 (FIG. 9) substantially greater than the thickness of the carrier 7, and a closed-end dimension D2 substantially the same as or less than the thickness of the carrier 7. Preferably, when the carrier is rotated to its locked position, the inner edge of the carrier is pinched in one or both of the slots 95 to secure the carrier in position. Preferably, the configuration is such that rotation of the carrier 7 tends to move the inner edge of the carrier 7 farther toward the closed end of the slot. By way of example, for a carrier 7 having an overall thickness of 184 microns, dimension D1 may be about 203 microns, and dimension D2 may be about 152 microns. The slot may have a length D3 of about 1.78 mm. These dimensions are exemplary only.

For additional details regarding the twist-lock construction of the carrier 7 and adapter 13, reference may be made to co-pending U.S. patent application Ser. No. 10/281,662, filed Oct. 28, 2002, the full disclosure of which is incorporated herein by reference. It will be understood that the specific construction of the securing mechanism 81 can vary without departing from the scope of this invention. For example, the number of flanges 85 and corresponding slots 95 in the hub 83 may be less or more than two flanges 85 and corresponding slots 95 shown in the drawings. The slot configuration can also vary. Further, the securing mechanism need not be a twist-lock device. For example, the mechanism could be of the type shown in PCT Publication No. WO/01/07240, published Feb. 1, 2001.

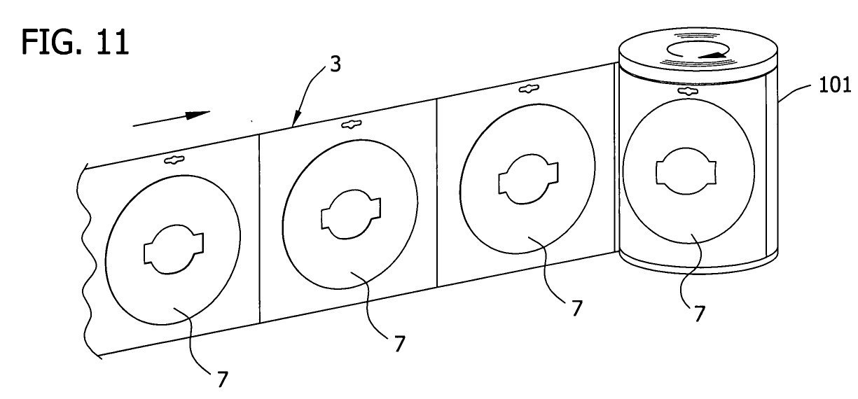

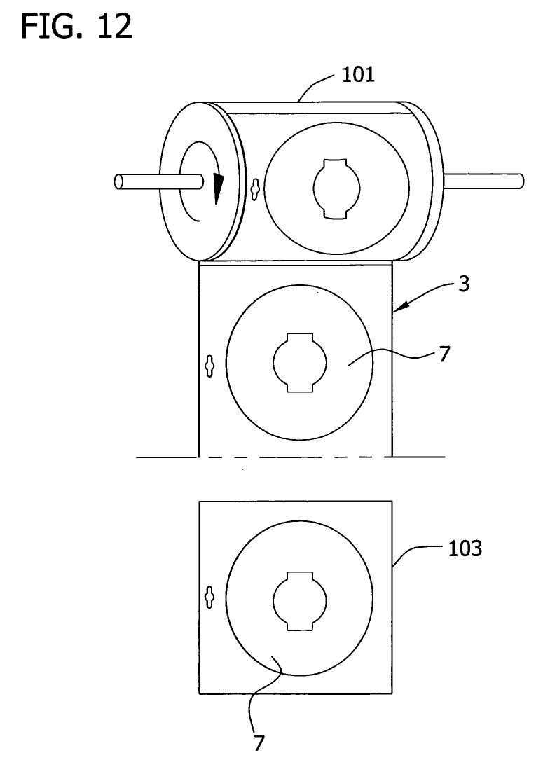

FIG. 11 illustrates a length of lamination 3 rolled up into a roll 101 for convenient storage and transport of the carriers 7. In use, selected lengths of the lamination 3 can be dispensed from the roll 101 and then cut to form individual sheets 103 containing the desired number of carriers 7 (see FIG. 12). When dispensed from the roll 101, the resiliency of the lamination 3 causes the lamination 3 (and the individual sheets 103) to return (spring back) to a relaxed, planar configuration suitable for playing on an optical CD-player. The roll form is advantageous because the roll 101 can be made to be compatible with existing roll-insertion equipment, including vending machines and other types of dispensers for dispensing CD's to consumers on demand. Further, laminations 3 from a plurality of rolls 101 can be collated to make books or other publications.

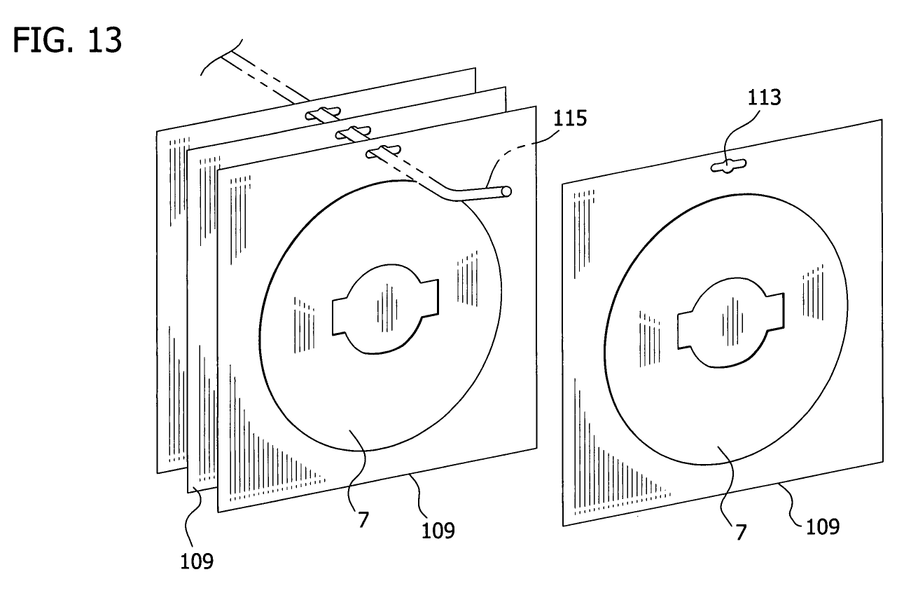

FIG. 13 illustrates another way to package a lamination of this invention. In this embodiment, the lamination comprises a number of sheets 109, each having an opening 113 in it to enable the sheets to be hung on a cantilever member of a display rack 115 or the like for convenient merchandising of the carriers 7 in stores and other facilities. Each sheet may include one or more data storage carriers.

FIGS. 14 and 15 illustrate examples of how graphics can be applied to the lamination of this invention. In FIG. 14, the lamination is in the form of a sheet 121 in which the carrier 7 is substantially smaller than the surrounding area of the sheet, thus creating a border area 125 around the carrier which can be used to display graphics. The size of this border area 125 can vary as needed or desired, depending for example on the desired amount of printing area. Graphics can be applied to the carrier 7 (e.g., the second surface 33B of the fourth carrier layer 33) and to the border area 125, as shown in FIG. 14. Alternatively, the graphics can be applied in the border area 125 only, as depicted in FIG. 15. Another option would be to apply graphics to the carrier 7 only, and not to the surrounding border area. The graphics can be applied in any number of ways, as by directly printing on the respective surfaces, or by adhering a separate sheet of graphics to the lamination. If by direct printing, the surfaces being printed are preferably ink-receptive. The graphics may be N-color graphics, where N is 1-4 or more. For example, FIGS. 14 and 15 illustrate one use of four different colors. Any color variation is possible.

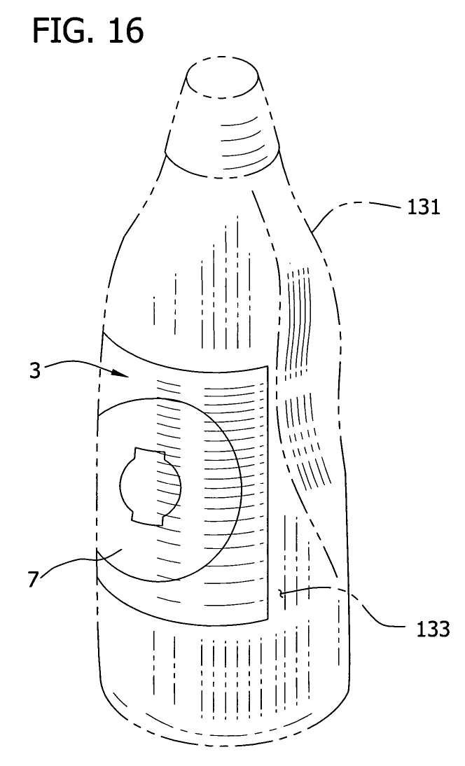

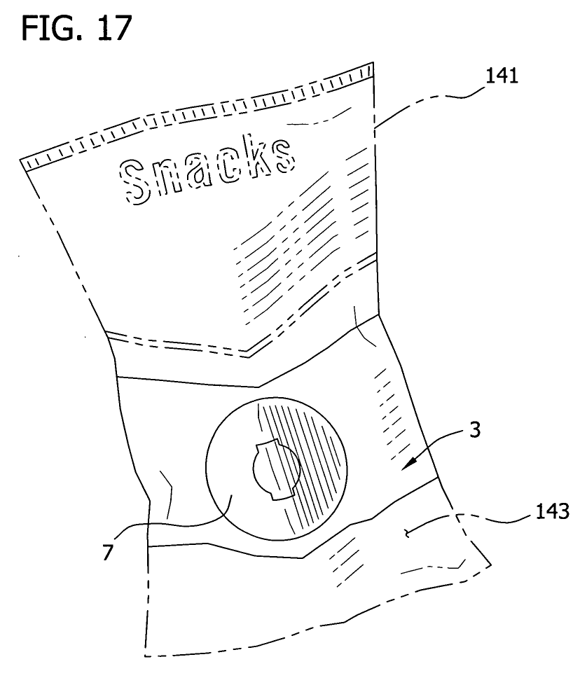

It will be observed from the foregoing that the optically readable storage medium 1 of the present invention, and the assembly of such a medium with an adapter 13 of this invention, has many advantages. Because the lamination of the substrate 5 and carrier(s) 7 is thin, light and resiliently flexible, a variety of packaging options are possible. For example, the lamination 3 can be applied to consumer products, including packaged goods, having curved and/or irregular non-planar surfaces, such as substantially rigid (including semi-rigid) containers having curved non-planar surfaces, one such container 131 having a rounded surface 133 being shown in FIG. 16. Such containers may include plastic and glass bottles and jars, paperboard boxes, metal cans, and other receptacles. The lamination 3 may also be affixed to packages of pliable material, such as the flexible bag 141 having an irregular surface 143 shown in FIG. 17. In this regard, the first surface 5A of the substrate 5 opposite the surface 5B carrying the carrier 7 is preferably compatible with adhesive or other affixing agent, so that the lamination 3 can be temporarily or permanently affixed to an object, either by application of the adhesive/agent to the substrate prior to affixation of the lamination to the object, or by application of the adhesive/agent to the object prior to affixation of the lamination. In any event, the substrate 5 functions as a mask to protect the optical surface (e.g., 27A) of the carrier from its environment until the time of its use. Because of the resilient flexibility of the lamination and the holding force between the carrier 7 and substrate 5, the carrier remains releasably attached to the substrate, without any separation (or at least substantial separation) from the substrate, until the consumer removes the carrier from the substrate 5. As a result, the carrier and/or substrate can be used for graphic enhancement of the consumer product.

In one embodiment, at least the first surface 5A of the substrate 5 is also ink receptive so that it may be printed on to provide even more options for graphic enhancement.

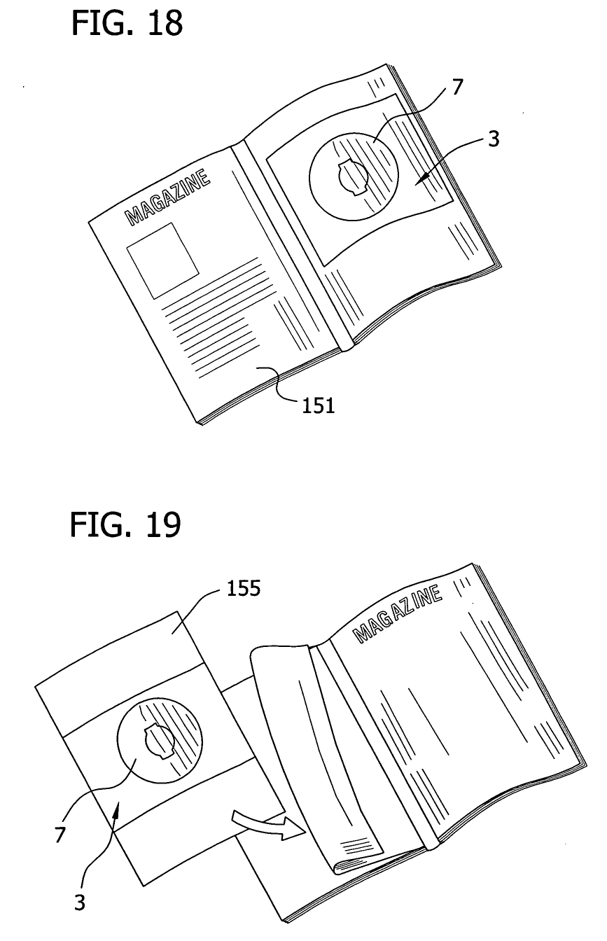

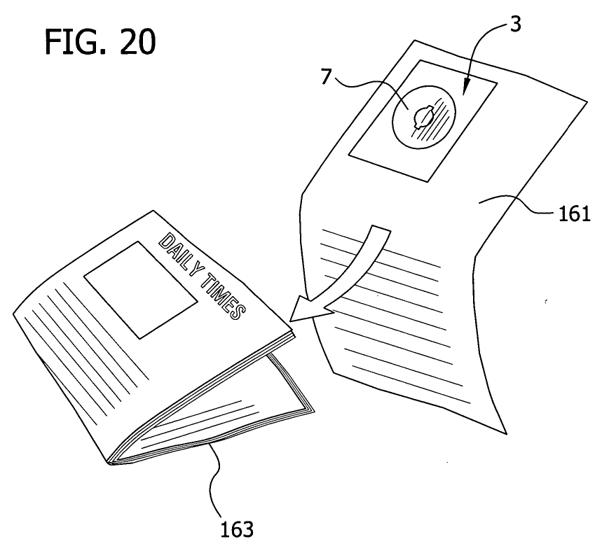

Optically readable storage medium of the present invention can also be distributed as an integral part of printed publications, such as magazines, catalogs, books, newspapers, greeting cards, postcards, pamphlets, mailings (e.g., direct mail), flyers, etc. (In this context, “integral” means that the storage medium remains with the publication until it is removed from the publication by the consumer.) FIG. 18 illustrates a lamination 3 adhered to a page of a catalog or magazine 151. In one embodiment, a suitable adhesive adheres the substrate 5 of the lamination 3 in place. In another embodiment (FIG. 19), the lamination 3 is adhered or otherwise secured to a flexible insert 155 which is placed in the catalog or magazine. Alternatively, the lamination 3 can be sized so that it can be placed lossely in the catalog or magazine 151 without securement to an insert. In still another embodiment, the lamination 3 can be fixedly bound in the catalog or magazine in the same manner as the pages are bound using binding equipment.

FIG. 20 illustrates a lamination 3 secured to a flexible insert 161 placed in a newspaper 163. In another embodiment (not shown), the lamination can be sized so that can be placed loosely in the newspaper without being attached to an insert. In still other embodiments (not shown), a lamination of this invention can be permanently or temporarily affixed by adhesive or the like to a part (page or cover) of a book, or adhered to an insert placed loosely in a book, or bound as a page in the book. In this regard, existing bindery equipment is suitable for insertion of flexible carriers of this invention into books, and other print media, thus providing significant cost and time savings for both the publisher and the advertiser.

In still another embodiment, a lamination 3 of the present invention may be used as an insert placed in an envelope in direct mail, either alone or accompanying other material. Alternatively, the lamination can be used without an envelope, similar to a postcard.

It will be apparent that other variations are possible, and that a lamination of this invention can be used with virtually any type of packaged consumer product and printed publication. Further, the laminations used in the ways described above may include any number of data carriers 7 from one to two or more. In general, the market applications available for carriers 7 of this invention are many, including audio sampling, video sampling, sales messaging, sweepstakes/games, software distribution, and product advertising.

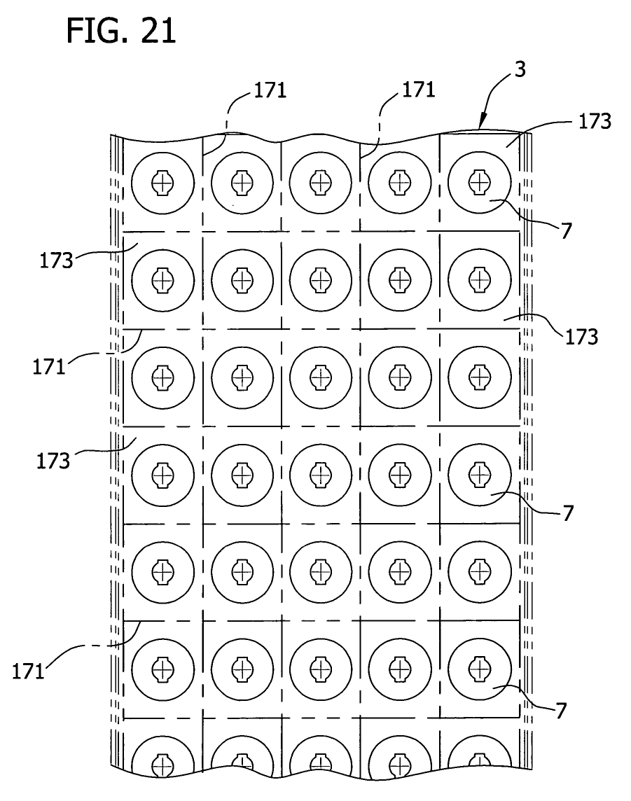

FIG. 21 illustrates a lamination 3 in the form of a continuous web having a series of carriers 7 thereon. The web is adapted to be cut along a series of cut lines 171 to form a multiplicity of separate rectangular sheets 173, each of which supports a single carrier 7. The carriers can be arranged in any geometric or non-geometric pattern on the web, and the individual sheets can be of any size and shape.

It will be observed from the foregoing that the thinness and resilient flexibility of the lamination/carrier enables one or more carriers to be distributed in many ways and in combination with virtually any consumer product or print media, including direct mail since a flexible carrier of this invention (unlike conventional rigid CD's) can readily survive the US Postal Service roller machinery used for automated mail processing. It will be noted in this regard that the lamination 3 and carrier(s) 7 thereon can be repeatedly flexed numerous times (e.g., at least about 25 times, more preferably at least about 50 times, still more preferably at least about 100 times, yet more preferably at least about 300 times, and more preferably at least about 500 times) without adversely affecting the optic readability of the carrier and without any separation (or at least without substantial separation) of the carrier 7 from the substrate 5. Once removed from the substrate 5, the carrier 7 is flexible a large number of times without adversely affecting the playability and readability of the carrier. By way of example, the carrier 7 is desirably flexible at least 100 times, more preferably at least about 1,000 times, and even more preferably at least about 5,000 times without adverse affect.

Other objects and features will be in part apparent and in part pointed out hereinafter.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions without departing from the scope of the invention, it is intended that all matter contained in the above description and shown in the accompanying drawing[s] shall be interpreted as illustrative and not in a limiting sense.

1. A thin, flexible, optically readable, data storage medium, comprising
a thin, flexible substrate, and
at least one thin, resiliently flexible, optically readable data storage carrier releasably held on said substrate, said at least one carrier having an axis of rotation and optically readable data tracks generally concentric with said axis of rotation,
said substrate and said at least one carrier thereon forming a thin flexible lamination which is resiliently deformable from a substantially planar configuration to a non-planar configuration without substantial separation of the carrier from the substrate and without adversely affecting the optic readability of the at least one carrier, said
said at least one carrier being adapted to be removed from the substrate for subsequent use with an optical reading device which is operable to rotate the at least one carrier to read said data tracks on the carrier.

2. A data storage medium as set forth in claim 1 wherein said at least one carrier comprises a plurality of carrier layers, and wherein said carrier has an outer periphery defined at least in part by a cut line extending through said plurality of carrier layers but not through said substrate.

3. A data storage medium as set forth in claims 1 or 2 wherein said at least one carrier is releasably held on said substrate by a holding force having a peel strength in the range of 10-60 grams.

4. A data storage medium as set forth in claims 1 or 2 wherein said at least one carrier is releasably held on said substrate by a holding force having a peel strength in the range of 16-26 grams.

5. A data storage medium as set forth in claim 3 wherein said at least one carrier is releasably held on said substrate without the use of adhesive.

6. A data storage medium as set forth in claim 5 wherein said at least one carrier and substrate have mating faces with finishes sufficiently smooth to generate an attraction force between said faces, said holding force comprising, at least in part, said attraction force.

7. A data storage medium as set forth in claim 6 wherein said finishes have a roughness of less than 2 rms.

8. A data storage medium as set forth in claim 1 or 2 wherein said substrate comprises a polymeric film having a thickness in the range of 25-76 microns.

9. A data storage medium as set forth in claim 1 or 2 wherein said substrate comprises a polymeric film having a thickness in the range of 25-50 microns.

10. A data storage medium as set forth in claim 1 wherein said carrier comprising a plurality of carrier layers superposed on said substrate, said plurality of carrier layers comprising a first carrier layer of substantially optically transparent resiliently flexible material having a first face superposed on said substrate and a second face, and a second carrier layer of substantially optically transparent resin having a first face superposed on the second face of the first layer and a second face having said data tracks thereon.

11. A data storage medium as set forth in claim 10 wherein said carrier has an outer periphery defined at least in part by a cut line extending through said first and second carrier layers but not through said substrate.

12. A data storage medium as set forth in claims 1 wherein said substrate comprises a film which is ink-receptive to allow ink graphics to be printed thereon.

13. A data storage medium as set forth in claims 1 or 2 wherein said at least one carrier comprises a plurality of carrier layers superposed on said substrate, said plurality of carrier layers including an ink-receptive layer printed with ink graphics.

14. A data storage medium as set forth in claim 1 wherein said lamination comprises a border area at least partially surrounding said at least one carrier, and wherein said border area is ink-receptive and printed with ink graphics.

15. A data storage medium as set forth in claim 14 wherein said ink graphics are printed in 2-color ink.

16. A data storage medium as set forth in claim 14 wherein said ink graphics are printed in 4-color ink.

17. A data storage medium as set forth in claims 1 or 2 wherein said at least one carrier comprises a plurality of data storage carriers on said substrate.

18. A data storage medium as set forth in claim 17 wherein each carrier of said plurality of carriers is in the form of a circular disc having a central aperture formed therein.

19. A data storage medium as set forth in claims 1 or 2 wherein said lamination is rolled up to form a roll from which a selected length of lamination can be dispensed.

20. A data storage medium as set forth in claims 1 or 2 wherein said lamination comprises a sheet having an opening therein for hanging the sheet from a display.

21. A data storage medium as set forth in claim 20 wherein said opening is sized for receiving a cantilever member of a display rack.

22. A data storage medium as set forth in claims 1 or 2 wherein said lamination is resiliently bendable to a curvature having a radius in the range of 20 mm-500 mm without substantial separation of the at least one carrier from the substrate and without adversely affecting the optic readability of the carrier.

23. A data storage medium as set forth in claims 1 or 2 wherein said lamination is resiliently bendable to a curvature having a radius in the range of 30 mm-200 mm without substantial separation of the at least one carrier from the substrate and without adversely affecting the optic readability of the carrier.

24. A data storage medium as set forth in claims 1 or 2 wherein said lamination is resiliently bendable to a curvature having a radius in the range of 35 mm-100 mm without substantial separation of the at least one carrier from the substrate and without adversely affecting the optic readability of the carrier.

25. A data storage medium as set forth in claims 1 or 2 wherein said at least one carrier has a flexural modulus in the range of 1200-3450 Mpa.

26. A data storage medium as set forth in claims 1 or 2 wherein said substrate is compatible with adhesive for securing the lamination to an object.

27. A data storage medium as set forth in claim 26 wherein said substrate has adhesive thereon for affixing said lamination to said object.

28. A data storage medium as set forth in claims 1 or 2 wherein said substrate is of a generally limp, non-resilient material and said carrier is resiliently flexible.

29. A data storage medium as set forth in claims 1 or 2 wherein said lamination can be repeatedly flexed without adversely affecting the optic readability of said at least one carrier.

30. A thin, flexible, optically readable, data storage medium, comprising
a thin, flexible substrate, and
at least one thin, resiliently flexible optically readable data storage carrier releasably held on said substrate by a holding force having a peel strength in the range of 10-60 gr,
said at least one carrier being adapted to be peeled off the substrate for use with an otical reading device operable to read data on the carrier.

31. A data storage medium as set forth in claim 30 wherein said holding force has a peel strength in the range of 16-26 gr.

32. A data storage medium as set forth in claim 30 wherein said at least one carrier is held on said substrate without the use of adhesive.

33. A data storage medium as set forth in claims 30, 31 or 32 wherein said at least one carrier and substrate have mating faces with finishes sufficiently smooth to generate an attraction force between said faces, said holding force comprising, at least in part, said attraction force.

34. A data storage medium as set forth in claim 33 wherein said finishes have a roughness of less than 2 rms.

35. A data storage medium as set forth in claim 30 wherein said at least one carrier comprises a plurality of carrier layers, and wherein said carrier has an outer periphery defined at least in part by a cut line extending through said plurality of carrier layers but not through said substrate.

36. A thin, resiliently flexible, optically readable, data storage medium in combination with a consumer product, said combination comprising
a thin, flexible substrate,
at least one thin, resiliently flexible, optically readable data storage carrier releasably held on said substrate, said at least one carrier having an axis of rotation and optically readable data tracks generally concentric with said axis of rotation,
said substrate and said at least one carrier thereon forming a thin resiliently flexible lamination resiliently deformable from a planar configuration to a non-planar configuration without substantial separation of the at least one carrier from the substrate and without adversely affecting the optic readability of the carrier, and
material releasably securing the lamination to a surface of said consumer product in a position wherein the at least one carrier is accessible for removal from the substrate whereupon the at least one carrier is adapted resiliently to assume its said planar configuration for use with an optical reading device which is operable to rotate the carrier to read said data tracks on the carrier.

37. A combination as set forth in claim 36 wherein said surface of the consumer product is a non-planar surface, and wherein said material releasably secures the lamination to said non-planar surface with the lamination resiliently deformed to conform to said non-planar surface.

38. A combination as set forth in claim 37 wherein said non-planar surface is substantially rigid.

39. A combination as set forth in claim 37 wherein said non-planar surface is flexible.

40. A combination as set forth in claims 38 or 39 wherein said non-planar surface is curved.

41. A combination as set forth in claim 36 wherein said consumer product comprises a flexible package.

42. A combination as set forth in claim 36 wherein said material is an adhesive on said substrate.

43. A combination as set forth in claim 36 wherein said lamination can be repeatedly flexed without adversely affecting the optic readability of said at least one carrier.

44. A combination as set forth in claim 36 wherein said at least one carrier comprises a plurality of carrier layers, and wherein said at least one carrier has an outer periphery defined at least in part by a cut line extending through said plurality of carrier layers but not through said substrate.

45. A thin, resiliently flexible, optically readable, data storage medium in combination with a printed publication, said combination comprising
a thin, flexible substrate,
at least one thin, resiliently flexible, optically readable data storage carrier releasably held on said substrate, said at least one carrier having an axis of rotation and optically readable data tracks generally concentric with said axis of rotation,
said substrate and said carrier thereon forming a thin resiliently flexible lamination resiliently deformable from a planar configuration to a non-planar configuration without substantial separation of the at least one carrier from the substrate and without adversely affecting the optic readability of the carrier,
said lamination forming an integral part of said flexible printed publication, and the at least one carrier being adapted to be removed from the substrate for use with an optical reading device which is operable to rotate the carrier to read said data tracks on the carrier.

46. A combination as set forth in claim 45 wherein said printed publication is a magazine or catalog, and wherein said lamination is secured to a page of the magazine or catalog.

47. A combination as set forth in claim 46 wherein said substrate of the lamination is adhered to said page of the magazine or catalog.

48. A combination as set forth in claim 45 wherein said printed publication is a magazine or catalog, and wherein said lamination is bound in the magazine or catalog.

49. A combination as set forth in claim 45 wherein said printed publication is a magazine or catalog, and wherein said lamination is an insert placed loosely in the magazine or catalog.

50. A combination as set forth in claim 45 wherein said printed publication is a newspaper, and wherein said lamination is secured to a page of the newspaper.

51. A combination as set forth in claim 50 wherein said substrate of the lamination is adhered to said page of the newspaper.

52. A combination as set forth in claim 45 wherein said printed publication is a newspaper, and wherein said lamination is an insert placed loosely in the newspaper.

53. A combination as set forth in claim 45 wherein said printed publication is a book, and wherein said lamination is secured to part of the book.

54. A combination as set forth in claim 53 wherein said substrate of the lamination is adhered to said part of the book.

55. A combination as set forth in claim 45 wherein said printed publication is a book, and wherein said lamination is bound in the book.

56. A combination as set forth in claim 45 wherein said printed publication is a book, and wherein said lamination is an insert placed loosely in the book.

57. A combination as set forth in claim 45 wherein said printed publication is a mailing, and wherein said lamination is secured to a page of the mailing.

58. A combination as set forth in claim 45 wherein said printed publication is a mailing in an envelope, and wherein said lamination is an insert placed in the envelope.

59. A combination as set forth in claim 45 wherein said lamination can be repeatedly flexed without adversely affecting the optic readability of said at least one carrier.

60. A combination as set forth in claim 45 wherein said at least one carrier comprises a plurality of carrier layers, and wherein said carrier has an outer periphery defined at least in part by a cut line extending through said plurality of carrier layers but not through said substrate.
